(19) United States
(12) Patent Application Publication
(10) Pub. No.: US 2003/0210946 A1
(43) Pub. Date: Nov. 13, 2003

(54) Electronic cartridge writing instrument

(76) Inventor: Stefaan De Schrijver, Newton, MA (US)

Correspondence Address: LAHIVE & COCKFIELD, 28 STATE STREET, BOSTON, MA, 02109, US

(21) Appl. No.: 10/299,979

(22) Filed: Nov. 19, 2002

Related U.S. Application Data
(63) Continuation of application No. PCT/US01/16413, filed on May 21, 2001.
(60) Provisional application No. 60/206,151, filed on May 22, 2000.

(51) Int. Cl. B43K 29/00; B43K 25/00

(52) U.S. Cl. 401/195; 401/52

(57) ABSTRACT

A writing instrument and associated carrier compartment that include electronic components. A communications link can be established between the writing instrument and the carrier compartment to allow dual direction communication between the carrier compartment and the writing instrument. A biometric database includes information for registered writing instrument users. A registered user can initiate data requests through the writing instrument, providing as authorization newly collected biometric data. The carrier compartment can receive the request, process the request by contacting a respective service or data provider, and transfer the request with the collected biometric data to the service provider. The service provider, as a subscriber to the biometric database, processes the request upon verification of the biometric data. A pre-established user account can reflect the requested transaction. Authorization or other data can be transferred to the carrier compartment and stored in a removable memory component such as a diskette or memory stick. The removable memory component data can be transferred to other electronic devices for authorization. Data requests may include any digital data including financial transactions, MP3 data, digital images, etc.

### RELATED INFORMATION

The present application is a continuation of PCT patent application number PCT/US01/16413, filed on May 21, 2001, which claims priority to U.S. provisional patent application No. 60/206,151, filed on May 22, 2000, the entire contents both of which are hereby incorporated by reference.

### BACKGROUND OF THE INVENTION

(1) Field of the Invention

The present invention relates generally to miniaturized electronic components, and more specifically to integrating miniature electronics with a writing implement structure.

(2) Description of the Prior Art

With increasing miniaturization of electronic devices, it is possible to incorporate certain electronic devices and functionality in common, portable structures. One such structure is the writing instrument, of which the pen is an example. The prior art discloses a combined input stylus and ink pen in a single unit wherein the stylus is located at one end and the ink writing tip is located at the opposing end. Also disclosed is an ornamental design for a two-ended pen that includes a plastic stylus tip and ink pen tip positioned at opposite ends. Alternately, another prior art system discloses a stylus tip to input information into electronic devices that are provided on the same end as the writing implement to allow the operator to quickly and easily switch between the stylus and ink tips.

Coincident with the miniaturization of electronics was the rapid public acceptance of the internet and the world-wide-web. The result is a large increase in remotely available products and services. The majority of these products and services are typically available through a computer attached to the network, but the increasingly mobile society is seeking access to such products and services without requiring access to a typical personal computer (PC) or other workstation. Laptop or notebook computers, although portable, cannot be practically operated in confined areas, and thus the popularity of Palmtop organizers, Palmtop computers, personal digital assistants, etc., has increased.

Although the Palmtop organizers are presently sufficient for storing and recalling personal data information, access to services and products offered by the internet are not generally available via the Palmtop organizers. As the internet expands, the available products and services increases. The available products and services include the download of MP3 music. The most recent electronic device to begin offering such access to the internet and its services is the cellular phone.

There is currently no electronic device in the form of a writing instrument that provides users with access to the increasing number of available electronic media and information.

What is needed is a compact structure, such as a writing instrument, that incorporates the latest advances in miniaturized electronic components with existing writing instrument functionality to allow access to electronic media, information, and services.

### SUMMARY OF THE INVENTION

The present invention is an apparatus that includes a writing instrument, wherein miniature electronic devices are incorporated into the writing instrument. The writing instrument can be coupled with a writing instrument carrier component that includes at least one removable memory module that can be compatible with other electronic devices. The writing instrument and the carrier component can maintain an electronic connection that can be wired or wireless. The carrier component additionally can connect to a network such as the internet. In one embodiment, the writing instrument can collect biometric data from a user, and the biometric data can be transmitted to the carrier component. The carrier component can then transfer the biometric data to another service provider accessible through the internet or other electronic network, wherein the user can be verified and/or authorized. Information can then be transferred back to the carrier component's memory module. In cases where a fee is required for this information processing and/or transfer, the biometric data can provide user authorization for the service fee. In another embodiment, the biometric data and/or validation results can be stored in a memory module included in the carrier component, and subsequently the memory module can be removed for insertion into another compatible device such as an audio player, personal computer, digital camera, cellular telephone, personal digital assistant, etc. Alternately, the biometric and/or validation data can be transferred to the writing instrument for display on a writing instrument display.

Other objects and advantages of the present invention will become more obvious hereinafter in the specification and drawings.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings, wherein like reference numerals refer to like parts and wherein:

FIG. 1 presents an illustrative architectural block diagram of one system practicing the concepts of the invention; and,

FIG. 2 displays a functional block diagram for an embodiment of the invention.

### DESCRIPTION OF THE ILLUSTRATED EMBODIMENTS

To provide an overall understanding of the invention, certain illustrative embodiments will now be described; however, it will be understood by one of ordinary skill in the art that the systems and methods described herein can be adapted and modified to provide systems and methods for other suitable applications and that other additions and modifications can be made to the invention without departing from the scope hereof.

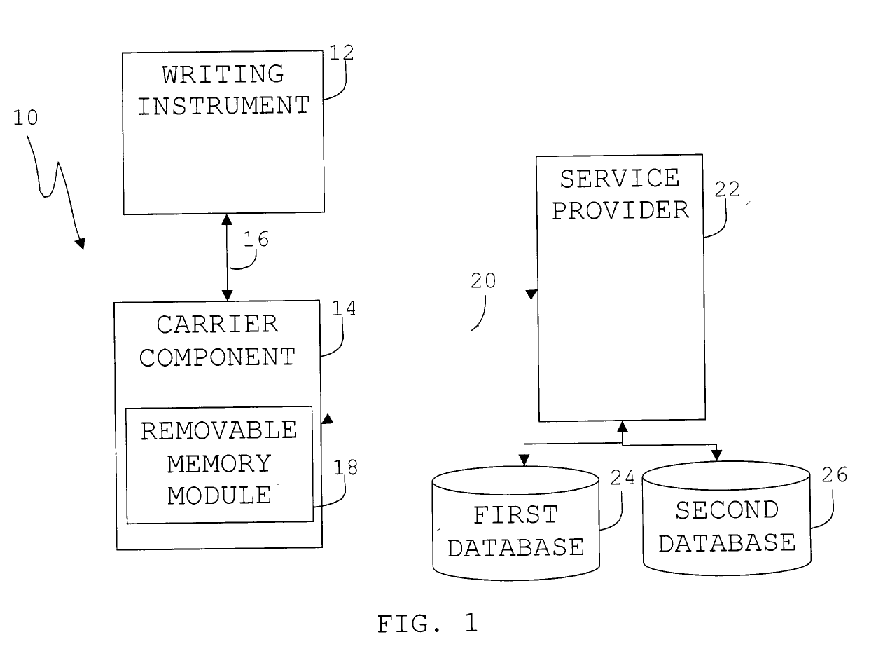

Referring now to FIG. 1, there is shown an illustrative architectural block diagram 10 of a system practicing the principles of the present invention. In the FIG. 1 system, a writing instrument 12 collects and provides biometric data to a carrier component or compartment 14 through an electrical connection 16. The writing instrument can be, for example, a pen, pencil, marker, stylus, or other writing instrument capable of generating communicative text. It is not necessary that the writing instrument operate on paper, display, or other surface, providing only that the writing instrument provides communicative text to an object, surface, or device. The writing instrument 12 can further be instrumented to collect biometric data including force, speed, angle, rotation, etc., of the writing instrument 12, although those with ordinary skill in the art will recognize that there are many types of biometric data that can be collected using a variety of sensors, and the invention herein is not limited to the type of biometric data collected, or the sensors utilized to collect such biometric data.

The electrical connection 16 between the writing instrument 12 and the carrier compartment 14 can be wired or wireless. Wireless connections can include, for example, infrared, radio frequency, ultrasound, or any other well-known wireless communication technique. Additionally, the connection 16 can be through contact by inserting the writing instrument 12 into a cartridge or other device that accepts the writing instrument 12 and facilitates the transfer of data between the writing instrument 12 and the carrier component 14. Similarly, the data transfer can occur using any number of data transfer protocols, and can include filtering, encoding, and other data communications techniques. It should be noted that the invention herein is not limited to the communications method or technique between the writing instrument 12 and the carrier component 14.

The FIG. 1 carrier component 14 additionally includes at least one removable memory module 18. In the illustrated embodiment, the removable memory modules 18 can be compatible with other electronic devices, thereby facilitating the transfer of the memory module data to other devices. Similarly, the removable memory modules 18 can include an executable program that can be originated from another electronic device. Examples of such removable memory modules include diskettes, compact disks, DVDs, and memory sticks, although such examples are provided merely for illustration and not limitation.

In the FIG. 1 embodiment, the carrier component 14 can maintain an electrical connection 20 to a service provider 22. The electrical connection 20 between the carrier component 14 and the service provider 22 can be wired or wireless. Once again, wireless connections can include infrared, radio frequency, ultrasound, spread spectrum (e.g., bluetooth) or any other well-known wireless communication technique. The connection 20 can also require a connection through the internet or other computer network. Similarly, the data communication between the carrier component 14 and the service provider 22 can utilize any combination of encryption, coding, and modulation technique that is well-known for data communications. Those with ordinary skill in the art will recognize that the invention herein is not limited to the communication method or technique between the carrier component 14 and the service provider 22.

In the FIG. 1 embodiment, the service provider 22 accepts newly collected biometric data from the carrier component 14, verifies the biometric data, and returns authorization and/or other data to the carrier component 14. The carrier component can store the data from the service provider 22 in the removable memory devices 18. Those with ordinary skill will recognize that processing performed by the service provider 22, and the data returned by the service provider to the carrier component 14, can vary widely depending upon application and the respective requirements. For example, the service provider 22 can access a first database 24 that can include biometric signature data, for example, to compare the newly collected biometric data information in the biometric database. One with ordinary skill in the art will recognize that some other indicia of ownership or identity can be established or otherwise provided to allow an identification of database 24 contents. In an embodiment, once the biometric data is authenticated, a second database 26 that includes, for example, a user profile or authorization account, can be accessed and thereafter transferred back to the carrier compartment 14. Those with ordinary skill in the art will recognize that the first database 24 and second database 26 can be implemented using any one of many well-known database programming tools including Microsoft Access, Excel, SQL, MySQL, Oracle, Informix, etc., and the invention herein is not limited to the type of database, database structure, or database contents. Additionally and optionally, the first and second databases 24, 26 can be combined in an embodiment, and the databases 24, 26 can be incorporated into the service provider or established to be in communications with the service provider.

The FIG. 1 service provider 22 can be, for example, a personal computer (PC), SUN™ workstation, handheld, Palmtop, laptop, telephone, or other device that can maintain a wired or wireless communications link, and can operate according to the principles of the invention as described herein and attributed to the device labeled service provider 22 in FIG. 1. For the purposes of this discussion, it shall be understood that references to the service provider 22 include references to all such other devices that can perform the functionality of the service provider 22 as described herein. The service provider 22 can access information sources that are accessible via a communication network, keyboard, digital camera, microphone, etc. Additionally and optionally, the service provider 22 can be equipped for processing multimedia data, and can be, for example, equipped with a sound and video card. The service provider 22 can operate as a stand-alone system or as part of a networked computer system. Alternatively, the service provider 22 can be a dedicated device, such as an embedded system, that can be incorporated into existing hardware devices, such as telephone systems, PBX systems, sound cards, etc.

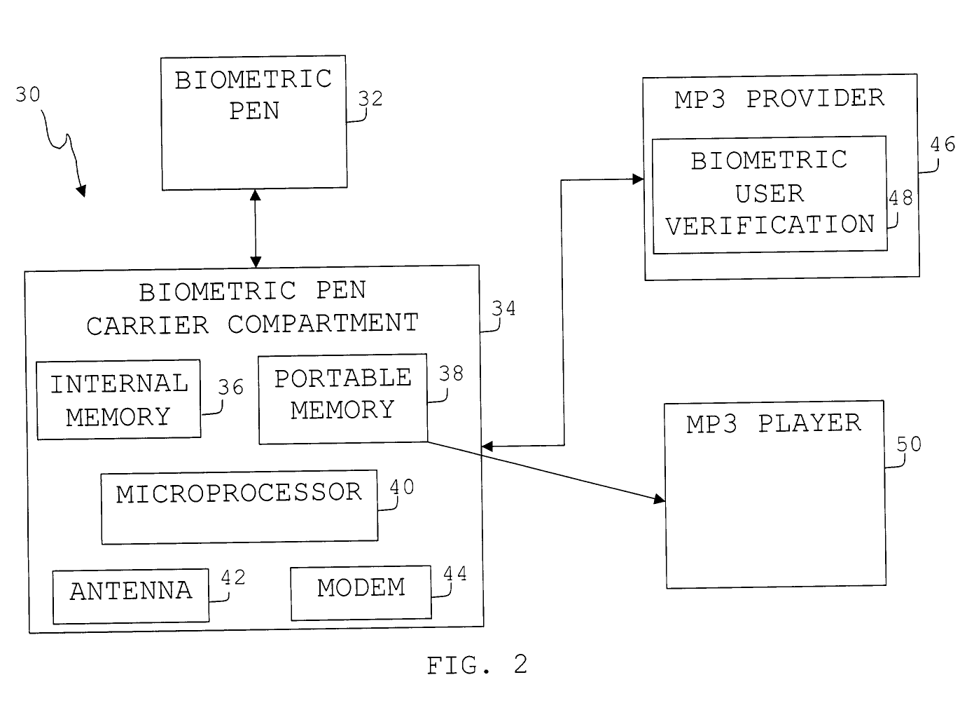

Referring now to FIG. 2, there is shown an embodiment of the invention 30 wherein the invention is used to access and download an MP3 file from an MP3 service provider. A MP3 file is well-known in the art as a MPEG 1 layer 3 file format used to compress audio files with negligible loss. MP3 files can be downloaded to local memory from a number of internet service providers, for example. After the file is downloaded to local memory, the audio file can be played with well known MP3 player devices, or the file may be converted to its original format wherein the data can be transferred to a compact disc. Several internet service providers allow subscribers to download MP3 files for a fee. These service providers typically require a credit card number from the subscriber to authorize the MP3 file transfer.

The FIG. 2 embodiment eliminates the requirement for a service provider, such as a MP3 service provider, to request credit card information from subscribers each time a subscriber request is received. In the FIG. 2 embodiment, the biometric writing instrument can be a biometric pen 32 that measures force and acceleration during a signature event, although the invention herein is not limited to such biometric data. The biometric pen 32 can also include a display with limited controls to select items on the display.

In the FIG. 2 system, a user is allowed to select, using the biometric pen display and limited controls therewith, an option to download a MP3 file. For example, the pen can be equipped with a selection button on a display or other part of the pen. The user can then prompted for a signature event, and upon executing the signature event, the biometric data collected during the signature event can be transferred to a biometric pen carrier compartment 34 that further includes an internal memory 36, a portable memory 38, a microprocessor 40, an antenna 42, and a modem 44. Those with ordinary skill in the art will recognize that the carrier compartment 34 and components thereof as shown in FIG. 2 are merely illustrative and do not limit the present invention.

In the illustrative embodiment of FIG. 2, the internal memory 36 can represent memory resident in the carrier compartment 34, can include one or more different types of memory, and can have different purposes including temporary storage, database storage, executing programs, etc. Alternately, the portable memory 38 can represent one or more removable memory modules as shown in FIG. 1. An example of such a module can include a diskette, compact disk, DVD, or memory stick. The FIG. 2 carrier compartment also includes a microprocessor 40 to control the various carrier compartment components and functionality. The antenna 42 allows the carrier compartment 34 to communicate with other devices, and can include any modular antenna, transmission port, or transmission mechanism, as the invention is not limited to the transmission mode or technique. Similarly, although FIG. 2 indicates a modem 44 that can be wired or wireless depending upon the communication scheme and other application-dependent requirements, the invention is not so limited.

In the FIG. 2 embodiment, the internal memory 36 can store the biometric data received from the biometrically-instrumented writing instrument or pen 32. The internal memory 36 can also include an executable program from which a pen user can select information, enter data, and is prompted for data. For the FIG. 2 system, also transmitted from the pen to the internal memory 36 can be a user selection of a MP3 file download. This information can be processed by the microprocessor 40 and thereafter cause the carrier compartment 34 to establish a communication link with a designated MP3 provider 46, whereupon the biometric data and the MP3 file download request can be transferred to the MP3 provider 46. It is not relevant to the invention whether the MP3 provider identity, location, and/or contact information is stored internally to the carrier compartment 34, or selected by the pen user via the display and controls located on the pen.

The illustrated, designated MP3 provider 46 is a subscriber to a biometric database that includes historical biometric profile data for designated individuals. The FIG. 2 system requires that the pen user be among the designated individuals with biometric profile data stored in the biometric database. Given the aforementioned conditions, the MP3 provider 46 can receive the user's biometric data from the user's signature event, verify the biometric data against the database information, and process the corresponding request upon appropriate verification (e.g. comparison of the signature event data and the database data) 48. Since the illustrated, designated MP3 provider 46 maintains account information for the pen user, the MP3 provider 46 can simply process the request and charge the user's account accordingly. The requested MP3 file can therefore be transferred from the MP3 provider 46 to the carrier compartment 34 and stored in the portable memory 38 on a device such as a memory stick. The memory stick or other portable memory device 38 can be extracted from the carrier compartment 34 and inserted into a MP3 player 50 for use. Depending upon the system sophistication, the user can be updated with transaction status on the pen display.

Although the embodiment illustrated by FIG. 2 demonstrated MP3 files as an application, other embodiments can include financial data, database information, digital images, and any other form of digital information. Similarly, as discussed with reference to FIG. 1, one or multiple databases can be used to provide information about the user. For example, once a user is authenticated, one database that includes credit card information can be used to charge the user for a processing fee and/or data transfer. Those with ordinary skill in the art will recognize many other applications for the methods and systems provided herein.

One advantage of the present invention is that the disclosed methods and systems provide a method of authenticating a user and delivering services to a user by using biometric information.

What has thus been described is a writing instrument and associated carrier compartment that include electronic components. A communications link can be established between the writing instrument and the carrier compartment to allow dual direction communication between the carrier compartment and the writing instrument. A biometric database includes information for registered writing instrument users. A registered user can initiate data requests through the writing instrument, providing as authorization newly collected biometric data. The carrier compartment can receive the request, process the request by contacting a respective service or data provider, and transfer the request with the collected biometric data to the service provider. The service provider, as a subscriber to the biometric database, processes the request upon verification of the biometric data. A pre-established user account can reflect the requested transaction. Authorization or other data can be transferred to the carrier compartment and stored in a removable memory component such as a diskette or memory stick. The removable memory component data can be transferred to other electronic devices for authorization. Data requests may include any digital data including financial transactions, MP3 data, digital images, etc.

Although the present invention has been described relative to a specific embodiment thereof, it is not so limited. Obviously many modifications and variations of the present invention may become apparent in light of the above teachings. For example, many of the functions disclosed herein may be combined without departing from the invention. The functions performed by the biometric pen and carrier compartment electronics may be divided differently between the biometric pen and the carrier compartment. The writing instrument need not be a pen, but can be a pencil, stylus, or any other writing implement allowing for writing on a surface. The writing surface is also not limiting of the invention.

Many additional changes in the details, materials, steps and arrangement of parts, herein described and illustrated to explain the nature of the invention, may be made by those skilled in the art within the principle and scope of the invention. Accordingly, it will be understood that the invention is not to be limited to the embodiments disclosed herein, may be practiced otherwise than specifically described, and is to be understood from the following claims, that are to be interpreted as broadly as allowed under the law.

What is claimed is:

1. A biometric writing instrument, comprising:
a carrier compartment further comprising at least one removable memory module; and
a communications link between the biometric writing instrument and the carrier compartment.

2. A biometric writing instrument according to claim 1, wherein the at least one removable memory module further comprises a diskette.

3. A biometric writing instrument according to claim 1, wherein the at least one removable memory module further comprises a compact disk (CD).

4. A biometric writing instrument according to claim 1, wherein the at least one removable memory module further comprises a digital video device (DVD).

5. A biometric writing instrument according to claim 1, wherein the at least one removable memory module further comprises a memory stick.

6. A biometric writing instrument according to claim 1, wherein the communications link is wireless.

7. A biometric writing instrument according to claim 1, wherein the communications link is wired.

8. A biometric writing instrument according to claim 1, wherein the communications link is infrared.

9. A biometric writing instrument according to claim 1, wherein the communications link is radio frequency (RF).

10. A biometric writing instrument according to claim 1, wherein the communications link is ultrasound.

11. A biometric writing instrument according to claim 1, wherein the communications link is established through contact of the biometric writing instrument and the carrier compartment.

12. A biometric writing instrument according to claim 1, further comprising a communications link between the carrier compartment and a microprocessor-controlled device.

13. A system for providing access to secure data, comprising,
a biometric writing instrument having a biometric sensor;
a carrier compartment for the biometric writing instrument, the carrier compartment in communication with the biometric writing instrument; and
a microprocessor in communication with the carrier compartment and capable of accessing secure data.

14. A system according to claim 13, wherein the biometric writing instrument further includes a selection module to provide a request.

15. A system according to claim 14, wherein the selection module further includes a display.

16. A system according to claim 13, wherein the carrier compartment further includes at least one removable memory device.

17. A system according to claim 13, wherein the carrier compartment further includes at least one static memory module.

18. A system according to claim 13, wherein the carrier compartment further includes at least one microprocessor.

19. A system according to claim 13, wherein the carrier compartment further includes at least one antenna for communicating to the microprocessor.

20. A system according to claim 13, wherein the carrier compartment further includes at least one modem.

21. A system according to claim 13, wherein the microprocessor further includes at least one database.

22. A system according to claim 13, further including at least one database to store the secure data.

23. A system according to claim 13, wherein the microprocessor further includes instructions to cause the microprocessor to receive a request from the carrier compartment, authenticate the request, conditionally process the request upon authentication, and transfer data responsive to the request to the carrier compartment.

24. A method for obtaining access to secure data, comprising:
receiving a data request for secure data;
receiving biometric information associated with the data request;
authenticating the biometric data; and
conditionally processing the data request based upon the authenticated biometric data.

25. A method according to claim 24, further comprising transferring the secure data to a requesting device.

26. A method according to claim 24, further comprising collecting an identity associated with the data request.

27. A method according to claim 24, wherein collecting biometric information further includes collecting at least one of an angle and force of a writing instrument during a writing event.

28. A method according to claim 24, further comprising storing the secure data in a removable memory device.

29. A method according to claim 24, wherein conditionally processing further comprises accessing user privileges based upon a user associated with the authenticated biometric data.
